(19) United States
(12) Patent Application Publication
(10) Pub. No.: US 2015/0376215 A1
(43) Pub. Date: Dec. 31, 2015

(54) Method Of Producing Phospholene Oxide

(71) Applicant: BASF SE, Ludwigshafen (DE)

(72) Inventors: Michael Yang, Ann Arbor, MI (US); Rajesh Kumar, Riverview, MI (US)

(21) Appl. No.: 14/767,779

(22) PCT Filed: Mar. 4, 2014
(86) PCT No.: PCT/US2014/020182

§ 371 Date: Aug. 13, 2015

Related U.S. Application Data
(60) Provisional application No. 61/776,820, filed on Mar. 12, 2013.

(51) Int. Cl. C07F 9/6568

(52) U.S. Cl. CPC C07F 9/65685

(57) ABSTRACT

A method of producing a phospholene oxide is disclosed. A dihalohydrocarbylphosphine, 2-methyl-1,3-butadiene, and a halogenated hydrocarbon solvent are combined to form an adduct via an addition reaction in a homogenous system wherein the ratio of the 2-methyl-1,3-butadiene to the dihalohydrocarbylphosphine is from 1.0 to 2.0 and wherein the solvent is present in an amount of greater than 200 mL per mole of dihalohydrocarbylphosphine. The adduct is combined with alcohol and a carbonate or with a solution of metal hydroxide and water to form the phospholene oxide.

### FIELD OF THE DISCLOSURE

The instant disclosure generally relates to a method of producing a phospholene oxide.

### BACKGROUND OF THE DISCLOSURE

Phospholene oxides are used to catalyze various chemical reactions. Phospholene oxides are typically produced by reacting dichlorophenylphosphine and 2-methyl-1,3-butadiene in the presence of an antioxidant to form an adduct which is solid. In one known synthetic pathway, the solid adduct is ground up and washed. Once washed, the adduct is combined with water and hydrolyzed to form a solution. The solution is neutralized with sodium hydroxide, and a phospholene oxide reaction product is formed in the neutralized solution. The phospholene oxide reaction product is extracted from the neutralized solution with a solvent, such as chloroform. The phospholene oxide reaction product is dried and then distilled to remove impurities and by-products and yield the phospholene oxide.

Traditional methods of producing phospholene oxides, such as the process described above, are time consuming and inefficient. For example, in the process above, the use of 2-methyl-1,3-butadiene as a starting material typically requires that the solid adduct be ground up and washed. Further, the chemical reaction that produces the phospholene oxide reaction product yields impurities and by-products which must be distilled to produce relatively pure phospholene oxide. Furthermore, the reactants used to form the phospholene oxide are typically expensive and the amount of phospholene oxide yielded is typically low, e.g. less than 80 percent. In addition, in the process described above, the yield of phospholene oxide typically decreases as reaction time decreases, and the amounts of reactants and solvents are decreased.

Accordingly, there remains an opportunity to develop an improved method of producing phospholene oxide which minimizes the use of solvents and reactants and quickly produces an increased yield of phospholene oxide.

### SUMMARY OF THE DISCLOSURE

A method of producing a phospholene oxide is disclosed and includes the step of combining a dihalohydrocarbylphosphine, 2-methyl-1,3-butadiene, and a halogenated hydrocarbon solvent to form an adduct via an addition reaction in a homogenous system wherein the ratio of the 2-methyl-1,3-butadiene to the dihalohydrocarbylphosphine is from 1.0 to 2.0 and wherein the solvent is present in an amount of greater than 200 mL per mole of dihalohydrocarbylphosphine. The method also includes the step of combining the adduct with alcohol and a carbonate or a solution of metal hydroxide and water, to form the phospholene oxide.

### DETAILED DESCRIPTION OF THE DISCLOSURE

The present disclosure provides a method of producing a phospholene oxide. Suitable examples of the phospholene oxide produced include, but are not limited to, 3-methyl-1-phenyl-2-phospholene oxide (“MPPO”), 3-methyl-1-ethyl-2-phospholene oxide (“MEPO”), 3,4-dimethyl-1-phenyl-3-phospholene oxide, 3,4-dimethyl-1-ethyl-3-phospholene oxide, 1-phenyl [symbol] -2-phospholen-1-oxide, 3-methyl-1-2-phospholen-1-oxide, 1-ethyl-2-phospholen-1-oxide, 3-methyl-1-phenyl-2-phospholen-1-oxide, and 3-phospholene isomers thereof. The phospholene oxide typically has one of the following two general structures:

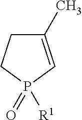

wherein R¹ is a hydrocarbon group;

### Structure A

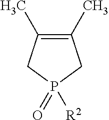 [0009] wherein R¹ is a hydrocarbon group.

### Structure B

Referring now to Structure A, R¹ may be an aryl group. In one embodiment, the aryl group is a phenyl group and the phospholene oxide is MPPO. MPPO is a particularly suitable phospholene oxide and has the following structure:

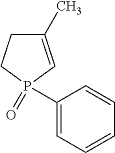

R¹ may also be an alkyl group. In one embodiment, the alkyl group is an ethyl group and the phospholene oxide is MEPO. MEPO is also a particularly suitable phospholene oxide and has the following structure:

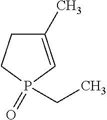

Referring now to Structure B, R² may be an aryl group. In one embodiment, the aryl group is a phenyl group and the phospholene oxide is 3,4-dimethyl-1-phenyl-3-phospholene oxide. 3,4-dimethyl-1-phenyl-3-phospholene oxide is a suitable phospholene oxide and has the following structure:

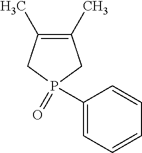

R² may be an alkyl group. In one embodiment, the alkyl group is an ethyl group, i.e., the phospholene oxide is 3,4-dimethyl-1-ethyl-3-phospholene oxide. 3,4-dimethyl-1-ethyl-3-phospholene oxide is a suitable phospholene oxide and has the following structure:

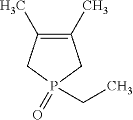

The method includes the step of combining a dihalohydrocarbylphosphine, 2-methyl-1,3-butadiene, and a halogenated hydrocarbon solvent to form an adduct. Typically, the step of combining is further defined as combining the halogenated hydrocarbon solvent with the dichlorophenylphosphine to form a mixture and then combining the mixture and the 2-methyl-1,3-butadiene.

The dihalohydrocarbylphosphine typically has the following general structure:

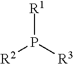

Wherein R¹ and R² are halogens and wherein R³ is a hydrocarbyl group.

R¹ and R² are halogens selected from the group of fluorine (F), chlorine (Cl), bromine (Br), iodine (I), and astatine (At). R³ may be an aryl group or an alkyl group.

In one embodiment, the dihalohydrocarbylphosphine is a dichlorohydrocarbylphosphine selected from the group of dichlorophenylphosphine, dichloromethylphosphine, dichloroethylphosphine, dichloropropylphosphine, dichlorobutylphosphine, and combinations thereof. However, the dihalohydrocarbylphosphine is not limited to the dichlorohydrocarbylphosphines set forth above.

The 2-methyl-1,3-butadiene is a colorless volatile liquid having the following formula: CH₂═C(CH₃)CH═CH₂ and a flash point of 54° C. (129° F.). Because of its volatility and flash point, the 2-methyl-1,3-butadiene is typically stored and/or used at a temperature below 35 (95), alternatively below 23 (73), alternatively from 0 to 35 (32 to 95), alternatively from 0 to 23 (32 to 73), alternatively from 0 to 15 (32 to 59), ° C. (° F.).

The dichlorophenylphosphine and the 2-methyl-1,3-butadiene typically react in an addition reaction to form the adduct. The molar ratio of the 2-methyl-1,3-butadiene to the dihalohydrocarbylphosphine reacted is typically from 1.0 to 2.0 (1:1 to 2:1), alternatively from 1.1 to 1.9 (1.1:1 to 1.9:1), alternatively from 1.2 to 1.8 (1.2:1 to 1.8:1), alternatively from 1.4 to 1.7 (1.4:1 to 1.7:1).

The addition reaction between the dihalohydrocarbylphosphine and the 2-methyl-1,3-butadiene is typically conducted in a homogenous system. The homogeneous system terminology describes a system utilizing a halogenated hydrocarbon solvent such as chloroform or methylene chloride. In contrast, a heterogeneous system typically utilizes a hydrocarbon solvent, i.e., a non-halagnated hydrocarbon solvent. The addition reaction is typically conducted in a homogeneous system. In a one embodiment, the halogenated hydrocarbon solvent is chloroform. The halogenated hydrocarbon solvent is typically used in an amount of greater than 200, alternatively from 200 to 500, alternatively from 200 to 300, mL per mole of dihalohydrocarbylphosphine.

The addition reaction between the dihalohydrocarbylphosphine and the 2-methyl-1,3-butadiene is typically conducted in the presence of an antioxidant. That is, the step of combining the dichlorophenylphosphine, 2-methyl-1,3-butadiene, and a halogenated hydrocarbon solvent is typically further defined as combining the dichlorophenylphosphine, 2-methyl-1,3-butadiene, the halogenated hydrocarbon solvent, and the antioxidant to form the adduct. Suitable, non-limiting examples of antioxidants include phenolic antioxidants, metal deactivators, amine antioxidants, phosphites, thiosynergists, hydroxylamines, and combinations thereof. In one embodiment, the antioxidant is a primary or free radical antioxidant. In this embodiment, the antioxidant typically has a hydroxyl (OH) or an amine (NH) group. For example, the primary antioxidant may be a hindered phenol or a secondary aromatic amine. In one embodiment, the antioxidant is a sterically hindered phenolic antioxidant such as butylated hydroxytoluene.

In one embodiment of the method, the step of combining the dihalohydrocarbylphosphine, 2-methyl-1,3-butadiene, and the halogenated hydrocarbon is further defined as charging the halogenated hydrocarbon solvent and the antioxidant into a reactor, subsequently charging the dihalohydrocarbylphosphine into the reactor, and finally charging the 2-methyl-1,3-butadiene into the reactor. Said differently, in this embodiment, the step of combining the dihalohydrocarbylphosphine, the 2-methyl-1,3-butadiene, and the halogenated hydrocarbon solvent to form the adduct is further defined as first combining the chloroform and the butylated hydroxytoluene, subsequently combining the dichlorophenylphosphine with the chloroform and the butylated hydroxytoluene, and then combining the 2-methyl-1,3-butadiene with the dichlorophenylphosphine, the chloroform, and the butylated hydroxytoluene. In one specific embodiment, chloroform and butylated hydroxytoluene are first charged into a reactor. Subsequently dichlorophenylphosphine is charged into the reactor. Finally, 2-methyl-1,3-butadiene is charged into the reactor.

The step of combining the dichlorophenylphosphine and 2-methyl-1,3-butadiene to form the adduct is typically conducted in less than 24, alternatively less than 22, alternatively less than 20, alternatively less than 18, alternatively less than 16, alternatively less than 14, alternatively less than 12, hours. Further, step of combining dichlorophenylphosphine and 2-methyl-1,3-butadiene to form the adduct is typically conducted at a temperature of from 45 to 80, alternatively from 50 to 70, ° C. In one specific embodiment, the step of combining the dihalohydrocarbylphosphine and the 2-methyl-1,3-butadiene to form the adduct is conducted at a temperature of about 65° C. and for a time period of less than 24 hours.

The method also includes the step of neutralizing the adduct. In one embodiment, the step of neutralizing the adduct is further defined as combining the adduct with alcohol and a carbonate to form the phospholene oxide. In this step, the adduct is neutralized to from the phospholene oxide.

One ore more different alcohols may be used in the step of neutralizing the adduct. The alcohol may be a primary, secondary, or tertiary alcohol. The alcohol may be a diol, a triol, or even a polyol. Examples of suitable alcohols include, but are not limited to methyl alcohol (methanol) CH₃OH, ethyl alcohol (ethanol) CH₃CH₂OH, n-propyl alcohol CH₃CH₂CH₂OH, isopropyl alcohol (propanol-2) CH₃CHOHCH₃, n-butyl alcohol (butanol-1) CH₃(CH₂)₂CH₂OH, butyl alcohol (butanol-2) CH₃CH₂CHOHCH₃, n-hexyl alcohol (hexanol-1) CH₃(CH₂)₄CH₂OH, n-heptyl alcohol (heptanol-1) CH₃(CH₂)₅CH₂OH, n-octyl alcohol (octanol-1) CH₃(CH₂)₆CH₂OH, and ethylene glycol CH₂OHCH₂OH, glycerol CH₂OHCHOHCH₂OH.

One ore more different carbonates may be used in the step of neutralizing the adduct. The carbonate may be an organic (e.g. dimethyl carbonate) or an inorganic carbonate (e.g. sodium bicarbonate). The carbonate can be a Group I metal carbonate. The carbonate is typically selected from the group of sodium bicarbonate, sodium carbonate, or combinations thereof. In one embodiment, the carbonate is sodium bicarbonate. In another embodiment, the carbonate is sodium carbonate. In this embodiment, the step of combining the adduct with alcohol and the carbonate in the reactor to form the phospholene oxide is conducted in less than 5, alternatively less than 4, alternatively less than 3, alternatively less than 2, alternatively less than 1, alternatively less than 0.5, alternatively less than 0.3, alternatively less than 0.1, hours.

To neutralize the adduct in the above embodiment, the alcohol and the carbonate are typically combined and mixed at a first temperature of from 23 to 60° C. for about 1 hour. Subsequently, the mixture is heated to a second temperature of greater than 65° C. to volatilize and remove excess solvent and other volatile compounds from the reactor. Said differently, the step of combining the adduct with the alcohol and the carbonate to form the phospholene oxide can be further defined as combining the adduct, with the alcohol and the carbonate, at the first temperature of from 23 to 60° C. and mixing for at least 1 hour and then heating the mixture to the second temperature of greater than 65° C. to volatilize and remove excess solvent and other volatile compounds.

When the method includes the step of neutralizing the adduct by combining the adduct with alcohol and the carbonate, the method is substantially free of water. Such a method is further defined as utilizing less than 5, alternatively less than 1, alternatively less than 0.5, percent by weight water, based on 100 percent by weight all components (e.g. reactants, solvents, antioxidants, etc.) used to form the phospholene oxide. Said differently, a method “substantially free of water” may be further defined as a method which utilizes less than 5, alternatively less than 1, alternatively less than 0.5, percent by weight water, based on 100 percent by weight all components (e.g. reactants, solvents, antioxidants, etc.) used to form the phospholene oxide. One embodiment may eliminate the use of water, which may otherwise be by-product that can be difficult to clean and recycle.

In another embodiment, the step of neutralizing the adduct is further defined as combining the adduct with a solution of metal hydroxide and water to form the phospholene oxide. The metal hydroxide can be a group I or Group II metal hydroxide. In one embodiment, the metal hydroxide is an alkali hydroxide including, but not limited to, lithium hydroxide (LiOH), sodium hydroxide (NaOH), potassium hydroxide (KOH), rubidium hydroxide (RbOH), caesium hydroxide (CsOH), and combination thereof. The solution of metal hydroxide and water may be a sodium hydroxide and water solution comprising 10 to 40, alternatively 20 to 30, alternatively about 25, percent by weight sodium hydroxide. However, the solution of sodium hydroxide and water is not limited to the compositional ranges set forth and may vary outside of these ranges. To neutralize the adduct in this embodiment, the solution of metal hydroxide and water is typically combined with the adduct and mixed at a temperature of from 23 to 60° C. and for at least 1 hour and then the mixture is heated to a temperature of greater than 65° C. (149° F.) to volatilize remove excess solvent and other volatile compounds from the reactor. In this embodiment, the step of combining the adduct with metal hydroxide and water in the reactor to form the phospholene oxide is conducted in less than 5, alternatively less than 4, alternatively less than 3, alternatively less than 2, alternatively less than 1, alternatively less than 0.5, hours.

The method also typically includes the step of extracting the phospholene oxide from reactor with an alkylphosphate solvent to form a phospholene oxide solution. In one embodiment, the alkylphosphate solvent is triethylphosphate (“TEP”). The step of extracting is typically conducted at a temperature of from 10 to 50, alternatively about 23, ° C. The step of extracting is typically conducted over a time period of less than 60, alternatively less than 30, alternatively less than 15, minutes. In one embodiment, the step of extracting is conducted at a temperature of about 23° C. and over a time period of less than 1 hour.

The phospholene oxide is typically extracted in greater than 80, alternatively greater than 85, alternatively greater than 90, alternatively greater than 95, alternatively greater than 96, alternatively greater than 97, alternatively greater than 98, alternatively greater than 99, percent of the theoretical yield and typically has a purity of greater than 50, alternatively greater than 65, alternatively greater than 75, percent by weight. Further, all of the phospholene oxide yielded with the method of this disclosure can be used, in lieu of pure products, in various reactions including the reaction of isocyanates, isocyanate reactive materials, and combinations thereof. Products formed with the phospholene oxide of the subject application have been contemplated herein, e.g., polyurethanes, polycarbodiimides, and hybrids thereof which are formed with the phospholene oxide.

In a typical embodiment of the method, a reactor is evacuated and a vacuum leak check is performed to determine a vacuum loss. The reactor typically maintains vacuum, with a pressure loss of less than 5 mm Hg (0.1 psi) over 10 minutes. After the vacuum leak check, the vacuum is typically withdrawn and the reactor is pressurized with nitrogen and/or a noble gas to 2586 mm Hg (50 psi). Once the reactor is pressurized, a pressure leak check is typically performed to determine a pressure loss. The reactor typically maintains pressure, with a pressure loss of less than 13 mm Hg (0.25 psi) over 15 minutes.

In various embodiments, the reactor is subsequently cooled to a temperature of about 25° C. (77° F.). The halogenated hydrocarbon solvent (e.g. chloroform) and the antioxidant (e.g. butylated hydroxytoluene) may then be charged into the reactor. A nitrogen blanket is then typically applied. The dihalohydrocarbylphosphine (e.g. dichlorophenylphosphine) is then typically charged into the reactor and the reactor may be agitated at a mix speed of from 100 to 150 RPM. The reactor is then typically vented and the 2-methyl-1,3-butadiene, having a temperature of 0 to 15 (32 to 59), ° C. (° F.), is charged into the reactor. The reactor is then typically sealed and agitated at an increased mix speed, e.g. of from 400 to 600 RPM.

In various embodiments, the reactor may then be cooled to a temperature of about 15° C. (59° F.), is purged with nitrogen and/or a noble gas. Once purged, the reactor is heated to a temperature of about 65° C. (149° F.) and the reaction may be allowed to progress for about 24 hours (from 23 to 25 hours) and to form the adduct.

In various embodiments, after formation of the adduct, the reactor may be vented and cooled, e.g. to a temperature of 25° C. (77° F.). Alcohol may then be charged into the reactor and the reactor may be purged with nitrogen and/or a noble gas, sealed, and may be set to a pre-determined mix speed, e.g. 200 to 600 RPM. After about 1 hour of mixing, the reactor may then be vented and the sodium bicarbonate charged therein. A charge port may then be sealed, an open vent line is established. The reactor temperature may then be set at about 45° C. (113° F.). The reactor may then be set to a mix speed of from 200 to 600 RPM and mixed for about an hour. The reactor may then be vented and a sample taken to determine the pH. The pH is typically from 6 to 7. If the pH is not from 6 to 7, the pH may be adjusted via the addition of a base, e.g. the carbonate. Once the pH has been adjusted, excess reactants and solvents are typically removed/stripped. The reactor temperature is gradually increased, e.g. to about 55° C. (131° F.) and excess methyl chloride and 2-methyl-1,3-butadiene are typically removed first. The reactor temperature is then typically increased again, e.g. to about 65° C. (149° F.), and the chloroform, alcohol and other reactants, solvents, additives and by-products are removed.

In various embodiments, once the excess reactants and solvents are stripped, the phospholene oxide is extracted from the reactor with an alkylphosphate solvent to form a phospholene oxide solution. More specifically, the reactor temperature may be increased to 75° C. (167° F.), a vacuum of <15 mm Hg (0.3 psi) applied, and triethyl phosphate (“TEP”) added to accomplish the extraction. In this embodiment, the alkylphosphate solvent is TEP and the step of extracting is typically conducted in about 15 minutes.

The following examples are intended to illustrate the present disclosure and are not to be read in any way as limiting to the scope of the present disclosure.

### EXAMPLES

### Example 1

### Production of 3-methyl-1-phenyl-2-phospholene oxide (MPPO)

Example 1 is a method of producing MPPO in accordance with the instant disclosure. The reactants, solvents, and additives, and amounts thereof used to form the MPPO are set forth in Table 1 below.

To start, a reactor is evacuated, i.e., a vacuum applied, and a vacuum leak check is performed to determine a vacuum loss. The reactor maintains vacuum, with the vacuum loss being less than 5 mm Hg (0.1 psi) over 10 minutes. After the vacuum leak check, the vacuum is withdrawn and the reactor is pressurized with nitrogen to 2586 mm Hg (50 psi). A pressure leak check is again performed to determine a pressure loss. The reactor maintains pressure, with the pressure loss being less than 13 mm Hg (0.25 psi) over 15 minutes. The reactor is then cooled to a temperature of about 25° C. (77° F.). A halogenated hydrocarbon solvent and an antioxidant are first charged into the reactor and a nitrogen blanket is applied to the reactor. A dihalohydrocarbylphosphine is subsequently charged into the reactor and a reactor mix speed is set at about 150 RPM. The reactor is then vented and 2-methyl-1,3-butadiene is charged into the reactor. Once the 2-methyl-1,3-butadiene is charged into the reactor, the reactor is sealed and the reactor mix speed is set at about 500 RPM. The reactor is then cooled to a temperature of about 23° C. (73° F.) and purged with nitrogen. Once purged, the reactor is heated to a temperature of about 65° C. (149° F.) and the reaction is allowed to progress for about 24 hours to form the adduct.

After 24 hours of agitation at about 65° C. (149° F.), the reactor is vented and cooled to a temperature of about 25° C. (77° F.). Alcohol is charged into the reactor and the reactor is purged with nitrogen, sealed, and set to a reactor mix speed of about 150 RPM. After about 1 hour of mixing, the reactor is then vented and the sodium bicarbonate is charged into the reactor. An open vent line is then established, and the reactor temperature is set at about 45° C. After venting, the reactor is then set at a reactor mix speed of about 150 RPM and mixed for about an hour. A sample of the contents of the reactor is taken to determine pH. The pH is from 6 to 7. If the pH is not from 6 to 7, the pH may be adjusted via the addition of the carbonate. Once the pH has been adjusted, excess reactants and solvents are removed/stripped. More specifically, the reactor temperature is gradually increased to about 55° C. (131° F.) and excess methyl chloride and 2-methyl-1,3-butadiene are removed first. The reactor temperature is increased again to about 65° C. (149° F.) and the chloroform, alcohol and other reactants, solvents, additives and by-products are removed.

Once the excess reactants and solvents are removed/stripped, the MPPO is extracted from the reactor with an alkylphosphate solvent to form a MPPO solution. More specifically, the reactor temperature is increased to 75° C. (167° F.), a vacuum of <15 mm Hg (0.3 psi) is applied, and TEP is added.

TABLE 1

| | | | Percent |
|---|---|---|---|
| | | | by |
| | | Charge | Weight |
| Description | Component | (g) | Total |
| Formation of the | Halogenated | 1258.0 | 33.8 |
| adduct via an | Hydrocarbon | | |
| addition reaction. | Solvent | | |
| | Antioxidant | 8.8 | 0.2 |
| | Dihalohydrocarbyl- | 528.0 | 14.2 |
| | phosphine | | |
| | 2-methyl-1,3- | 302.0 | 8.1 |
| | butadiene | | |
| Formation of the | Alcohol | 1205 | 32.4 |
| phospholene oxide | Carbonate | 421 | 11.3 |
| via a alcoholysis | | | |
| neutralization | | | |
| reaction. | | | |
| | Total | 3723.1 | 100.0 |
| Strip Excess | 2-methyl-1,3- | −100.5 | — |
| Reactants, Solvents, | butadiene | | |
| By-products, Etc. | Methyl Chloride | −44.9 | — |
| | Produced | | |
| | Alcohol | −1176.6 | — |
| | Halogenated | −1258.0 | — |
| | Hydrocarbon | | |
| | Solvent | | |
| | NaCl Salts Produced, | −491.9 | — |
| | Carbonate, and | | |
| | Antioxidant | | |
| Phospholene Oxide | 3-methyl-1-phenyl-2- | 651.2 | 39.9 |
| Solution | phospholene oxide | | |
| | Carrier Solvent | 980 | 60.1 |
| | Total | 1631.2 | 100.0 |

| | |
|---|---|
| Molar Ratio: | 1.52 |
| (2-methyl-1,3- | |
| butadiene: | |
| Dihalohydrocarbyl- | |
| phosphine) | |
| Solvent Amount | 284 |
| (mL per mole of | |
| Dihalohydrocarbyl- | |
| phosphine) | |
| MPPO Yield (%) | 96.8 |
| MPPO Purity (%) | 65.1 |

Halogenated Hydrocarbon Solvent is chloroform.
Antioxidant is butylated hydroxyltoluene.
Dihalohydrocarbylphosphine is dichlorophenylphosphine.
Carbonate is sodium bicarbonate.
Alcohol is methanol.
Carrier Solvent is TEP.

### Example 2

### Production of 3-methyl-1-phenyl-2-phospholene oxide (MPPO)

Example 2 is also a method of producing MPPO in accordance with the instant disclosure. The reactants, solvents, and additives, and amounts thereof used to form the MPPO are set forth in Table 2 below.

To start, a reactor is evacuated, i.e., a vacuum applied, and a vacuum leak check is performed to determine a vacuum loss. The reactor maintains vacuum, with the vacuum loss being less than 5 mm Hg (0.1 psi) over 10 minutes. The vacuum is withdrawn and the reactor is pressurized with nitrogen to 2586 mm hg (50 psi). After the vacuum leak check, a pressure leak check is again performed to determine a pressure loss. The reactor maintains pressure, with the pressure loss being less than 13 mm hg (0.25 psi) over 15 minutes. The reactor is then cooled to a temperature of about 25° C. (77° F.). The halogenated hydrocarbon solvent and the antioxidant are first charged into the reactor and a nitrogen blanket is then applied. The dihalohydrocarbylphosphine is then charged into the reactor and a reactor mix speed is set at about 150 RPM. The reactor is then vented and 2-methyl-1,3-butadiene, having a temperature of about 0° C. (32° F.), is charged into the reactor. Once the 2-methyl-1,3-butadiene is charged into the reactor, the reactor is sealed and the reactor mix speed is set at about 500 RPM. The reactor, cooled to a temperature of about 23° C. (73° F.), is purged with nitrogen. Once purged, the reactor is heated to a temperature of about 65° C. (149° F.) and the reaction is allowed to progress for about 24 hours to form the adduct.

In contrast to the method of Example 1, the method of Example 2 includes the step of neutralizing the adduct with a solution of metal hydroxide and water via a hydrolysis reaction. As such, after 24 hours of agitation at about 65° C. (149° F.), the reactor is vented and cooled to a temperature of about 25° C. (77° F.). The solution of metal hydroxide and water is gradually charged into the reactor and the reactor is purged with nitrogen, sealed, and the reactor mix speed is set at 150 RPM. After about 20 hours of mixing, the reactor is vented. Once mixed and vented, excess reactants and solvents are removed/stripped. More specifically, the reactor temperature is gradually increased to about 55° C. (131° F.) and excess 2-methyl-1,3-butadiene is removed first. The reactor temperature is increased again to about 65° C. (149° F.) and the chloroform and other reactants, solvents, additives and by-products are removed.

Once the excess volatile reactants and solvents are removed/stripped, the MPPO is extracted from the reactor.

TABLE 2

| | | | Percent |
|---|---|---|---|
| | | | by |
| | | Charge | Weight |
| Description | Component | (kg) | Total |
| Formation of the | Halogen-containing | 1641.75 | 58.09 |
| adduct via an | Hydrocarbon Solvent | | |
| addition reaction. | Antioxidant | 12.46 | 0.44 |
| | Dihalohydrocarbyl- | 746.25 | 26.40 |
| | phosphine | | |
| | 2-methyl-1,3- | 426.04 | 15.07 |
| | butadiene | | |
| | Total | 2826.50 | 100.00 |
| Strip Excess | 2-methyl-1,3- | −142.01 | — |
| Reactants, | butadiene | | |
| Solvents, | Halogenated | −902.96 | — |
| By-products, Etc. | Hydrocarbon | | |
| | Solvent | | |
| Formation of the | Solution of metal | 1314.21 | — |
| phospholene | hydroxide and water | | |
| oxide via a | (25%) | | |
| hydrolysis | Deionized Water | 371.952 | — |
| neutralization | | | |
| reaction. | | | |
| Decant Salt Water | Salt Water | −1912.66 | — |
| Water Wash | Deionized Water | 1555.01 | — |
| Final Solvent | Halogenated | −738.79 | — |
| Stripping | Hydrocarbon | | |
| | Solvent | | |
| | Residual Salt and | −12.46 | — |
| | Antioxidant | | |
| Phospholene Oxide | 3-methyl-1-phenyl-2- | 803.76 | — |
| | phospholene oxide | | |

| | |
|---|---|
| 2-methyl-1,3- | 1.5 |
| butadiene: | |
| Dihalohydrocarbyl- | |
| phosphine | |
| Ratio | |
| Solvent Amount | 265 |
| (mL per mole of | |
| dihalohydrocarbyl- | |
| phosphine) | |
| MPPO Yield (%) | 99.1 |
| MPPO Purity (%) | 75.4 |

The solution of metal hydroxide and water is a 25% solution of sodium hydroxide and water.

As such, the processes of Examples 1 and 2 yield greater than 95% of the theoretical yield of a phospholene oxide product at a purity of greater than 65%. Further, all of the phospholene oxide product yielded can be used, in lieu of pure products, in various reactions including the reaction of isocyanates, isocyanate reactive materials, and combinations thereof.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the instant disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the instant disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The instant disclosure has been described in an illustrative manner, and it is to be understood that the terminology which has been used is intended to be in the nature of words of description rather than of limitation. Obviously, many modifications and variations of the instant disclosure are possible in light of the above teachings. It is, therefore, to be understood that within the scope of the appended claims, the instant disclosure may be practiced otherwise than as specifically described.

1. A method of producing a phospholene oxide, said method comprising the steps of:
combining a dihalohydrocarbylphosphine, 2-methyl-1,3-butadiene, and a halogenated hydrocarbon solvent to form an adduct via an addition reaction in a homogenous system wherein a molar ratio of the 2-methyl-1,3-butadiene to the dihalohydrocarbylphosphine is from 1.0 to 2.0 and wherein the halogenated hydrocarbon solvent is present in an amount of greater than 200 mL per mole of dihalohydrocarbylphosphine; and
combining the adduct with alcohol and a carbonate, or a solution of metal hydroxide and water to form the phospholene oxide; and
extracting the phospholene oxide with an alkylphosphate solvent to form a phospholene oxide solution.

2. A method as set forth in claim 1 wherein the step of extracting is conducted at a temperature of about 23° C. and/or for a time period of less than 1 hour.

3. A method as set forth in claim 1 wherein the alkylphosphate solvent is triethylphosphate.

4. A method as set forth in claim 1 which yields greater than 80 percent by weight of the phospholene oxide.

5. A method as set forth in claim 1 wherein the dihalohydrocarbylphosphine is selected from the group of dichlorophenylphosphine, dichloromethylphosphine, dichloroethylphosphine, dichloropropylphosphine, dichlorobutylphosphine, and combinations thereof.

6. A method as set forth in claim 1 wherein the dihalohydrocarbylphosphine is dichlorophenylphosphine.

7. A method as set forth in claim 1 wherein the step of combining the dihalohydrocarbylphosphine, the 2-methyl-1,3-butadiene, and the halogenated hydrocarbon solvent to form the adduct is further defined as combining the halogenated hydrocarbon solvent and the dihalohydrocarbylphosphine to form a mixture and combining the mixture with the 2-methyl-1,3-butadiene.

8. A method as set forth in claim 1 wherein the step of combining the dihalohydrocarbylphosphine, the 2-methyl-1,3-butadiene, and the halogenated hydrocarbon solvent is further defined as combining the dihalohydrocarbylphosphine, the 2-methyl-1,3-butadiene, the halogenated hydrocarbon solvent, and an antioxidant to form the adduct.

9. A method as set forth in claim 8 wherein the halogenated hydrocarbon solvent is chloroform, the dihalohydrocarbylphosphine is dichlorophenylphosphine, and the antioxidant is butylated hydroxytoluene.

10. A method as set forth in claim 9 wherein the step of combining the dichlorophenylphosphine, the 2-methyl-1,3-butadiene, the chloroform, and the butylated hydroxytoluene to form the adduct is further defined as:
combining the chloroform and the butylated hydroxytoluene,
subsequently combining the dichlorophenylphosphine with the chloroform and the butylated hydroxytoluene, and
subsequently combining the 2-methyl-1,3-butadiene with the dichlorophenylphosphine, the chloroform, and the butylated hydroxytoluene.

11. A method as set forth in claim 1 wherein the step of combining is conducted in less than 24 hours.

12. A method as set forth in claim 1 wherein the molar ratio of the 2-methyl-1,3-butadiene to the dihalohydrocarbylphosphine is from 1.4 to 1.7.

13. A method as set forth in claim 1 wherein the step of combining the adduct with the alcohol and the carbonate to form the phospholene oxide is conducted in less than 5 hours.

14. A method as set forth in claim 1 wherein the step of combining the adduct with the alcohol and the carbonate to form the phospholene oxide is further defined as mixing the adduct with the alcohol and the carbonate at a first temperature of from 23 to 60° C. and for at least 1 hour and then heating the alcohol and the carbonate to a second temperature of greater than 65° C. to volatilize and remove excess solvent.

15. A method as set forth in claim 1 which is substantially free of water.

16. A method as set forth in claim 1 wherein the solution of metal hydroxide and water comprises 10 to 40 percent by weight sodium hydroxide.

17. A method as set forth in claim 1 wherein the step of combining is conducted at a temperature of from 45 to 80° C.

18. A method as set forth in claim 11 wherein the step of combining is conducted at a temperature of from 45 to 80° C.

19. A method as set forth in claim 10 wherein the molar ratio of the 2-methyl-1,3-butadiene to the dihalohydrocarbylphosphine is from 1.4 to 1.7.

20. A method as set forth in claim 2 method wherein the alkylphosphate solvent is triethylphosphate.
